(19) United States
(12) Patent Application Publication
(10) Pub. No.: US 2015/0310394 A1
(43) Pub. Date: Oct. 29, 2015

(54) SYSTEM AND METHOD OF HIRING, ONBOARDING, AND COLLABORATING

(71) Applicant: HRcube LLC, Indianapolis, IN (US)

(72) Inventor: Sudhan SHANMUGASUNDARAM, Indianapolis, IN (US)

(73) Assignee: HRCUBE LLC, Indianapolis, IN (US)

(21) Appl. No.: 14/692,275

(22) Filed: Apr. 21, 2015

Related U.S. Application Data
(60) Provisional application No. 61/986,027, filed on Apr. 29, 2014.

(51) Int. Cl. G06Q 10/10

(52) U.S. Cl. CPC G06Q 10/1053; G06Q 10/1095

(57) ABSTRACT

An apparatus and method for hiring, onboarding, and collaborating. The system and method may utilize a server and user interfaces to facilitate the posting of job openings, the narrowing of a pool of jobseekers, the scheduling of interviews, and the selection of a jobseeker for hire. Once hired, the system and method may facilitate the onboarding process through the sharing of documents and other necessary information. The system and method may additionally allow for collaboration among users.

### PRIORITY CLAIM

This application claims priority to U.S. Provisional Application No. 61/986,027, filed Apr. 29, 2014, the contents of which are herein incorporated by reference.

### BACKGROUND

In conventional recruiting, professional recruiters often use automated tools to search databases of jobseekers for candidates matching certain characteristics. Professional recruiters may then submit matching candidate profiles or resumes to an employer. Generally, professional recruiters lack expertise in a specific employment field and must match candidates based on certain degrees or keywords from their resumes or profiles that match a job. It is impractical for a professional recruiter to have expertise in a particular field due to the vast number of fields they may encounter. A pool of matching candidates, based on the limited criteria, may be provided to a potential employer. The potential employer may then sort through the pool of candidates to select the best matches based on not only attributes desired by the employer, but also adequate knowledge and skill in the appropriate field.

### SUMMARY

According to an exemplary embodiment, a method of recruiting and onboarding may be provided. A hiring, onboarding, and collaborating system having a server configured to store and compare employer data, job posting data, jobseeker data, and professional data may be provided. A user interface for employers, jobseekers, professionals, and coordinators may additionally be provided. An employer may be allowed to post a job opening through the system, such that jobseekers can apply for posted job openings. An algorithm may be run by the system to narrow a pool of jobseekers for a given opening. A coordinator may further narrow a jobseeker pool using professional review and interviews. The narrowed jobseeker pool may be provided to the employer for final review and selection. A jobseeker may then be selected for hire. Once hired, all necessary documents and information may be provided to the new hire. Employment contracts may be signed and transferred through the system between the new hire and the employer. Feedback may then be requested from the employer, jobseekers, and professionals.

According to another exemplary embodiment, a recruiting and onboarding system may be provided. The recruiting and onboarding system may include at least one server and at least one network. At least one employer device may be configured to communicate with the at least one server over the at least one network. At least one jobseeker device may be configured to communicate with the at least one server over the at least one network. At least one coordinator device may be configured to communicate with the at least one server over the at least one network. At least one professional device may be configured to communicate with the at least one server over the at least one network. The at least one server may be configured to allow an employer to create a profile and allow the employer to post a job opening such that a jobseeker may apply for the opening. The server may further search and narrow a jobseeker pool based on job opening information and jobseeker data. The server may additionally allow at least one coordinator or professional to further narrow the jobseeker pool for submission to the employer. Finally, the server may allow an employer to select a jobseeker for hire based on the data.

### BRIEF DESCRIPTION OF THE DRAWINGS

Advantages of embodiments of the present invention will be apparent from the following detailed description of the exemplary embodiments. The following detailed description should be considered in conjunction with the accompanying figures in which:

FIG. 1 is a diagram showing an exemplary embodiment of hiring, onboarding, and collaborating;

FIG. 2 is a diagram showing an exemplary embodiment of hiring, onboarding, and collaborating;

FIG. 3 is a diagram showing an exemplary embodiment of hiring, onboarding, and collaborating;

FIG. 4 is a diagram showing an exemplary embodiment of hiring, onboarding, and collaborating;

FIG. 5 is a diagram showing an exemplary embodiment of hiring, onboarding, and collaborating;

FIG. 6 is a diagram showing an exemplary embodiment of hiring, onboarding, and collaborating;

FIG. 7 is a diagram showing an exemplary embodiment of hiring, onboarding, and collaborating;

FIG. 8 shows an exemplary community interface;

FIG. 9 shows an exemplary hiring manager dashboard interface;

FIG. 10 shows an exemplary hiring manager profile interface;

FIG. 11 shows an exemplary professional dashboard interface;

FIG. 12 shows an exemplary professional profile interface;

FIG. 13 shows an exemplary job seeker dashboard interface;

FIG. 14 shows an exemplary job seeker profile interface;

FIG. 15 shows an exemplary job search interface;

FIG. 16 shows an exemplary job details interface;

FIG. 17 shows an exemplary professional feedback interface;

FIG. 18 shows an alternative exemplary community interface; and

FIG. 19 shows an exemplary home page interface.

### DETAILED DESCRIPTION

Aspects of the present invention are disclosed in the following description and related figures directed to specific embodiments of the invention. Those skilled in the art will recognize that alternate embodiments may be devised without departing from the spirit or the scope of the claims. Additionally, well-known elements of exemplary embodiments of the invention will not be described in detail or will be omitted so as not to obscure the relevant details of the invention.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

Further, many of the embodiments described herein may be described in terms of sequences of actions to be performed by, for example, elements of a computing device. It should be recognized by those skilled in the art that the various sequence of actions described herein can be performed by specific circuits (e.g., application specific integrated circuits (ASICs)) and/or by program instructions executed by at least one processor. Additionally, the sequence of actions described herein can be embodied entirely within any form of computer-readable storage medium such that execution of the sequence of actions enables the processor to perform the functionality described herein. Thus, the various aspects of the present invention may be embodied in a number of different forms, all of which have been contemplated to be within the scope of the claimed subject matter. In addition, for each of the embodiments described herein, the corresponding form of any such embodiments may be described herein as, for example, “a computer configured to” perform the described action.

An exemplary embodiment of a collaborative system and platform for hiring, onboarding, and collaborating with jobseekers and hiring managers may be provided. In an exemplary embodiment, the system may utilize software implemented by a processor configured to perform the functions described herein. The system may be a web-based platform and may run on cloud-based infrastructure. This may allow the platform to easily be scaled as required. The system may further include at least one database server optionally containing jobseeker information, employer information, job opening information, and professional information. Various parties may interact with the system over a network, such as recruiting coordinators, employers, jobseekers, and professionals. Recruiting coordinators may replace conventional recruiters in the process. Professionals may be experienced in a particular field and may be capable These parties may interact with the system through specific user interfaces, including websites or software applications, such as PC software applications and mobile software applications. The system may further be integrated with users' social networking accounts.

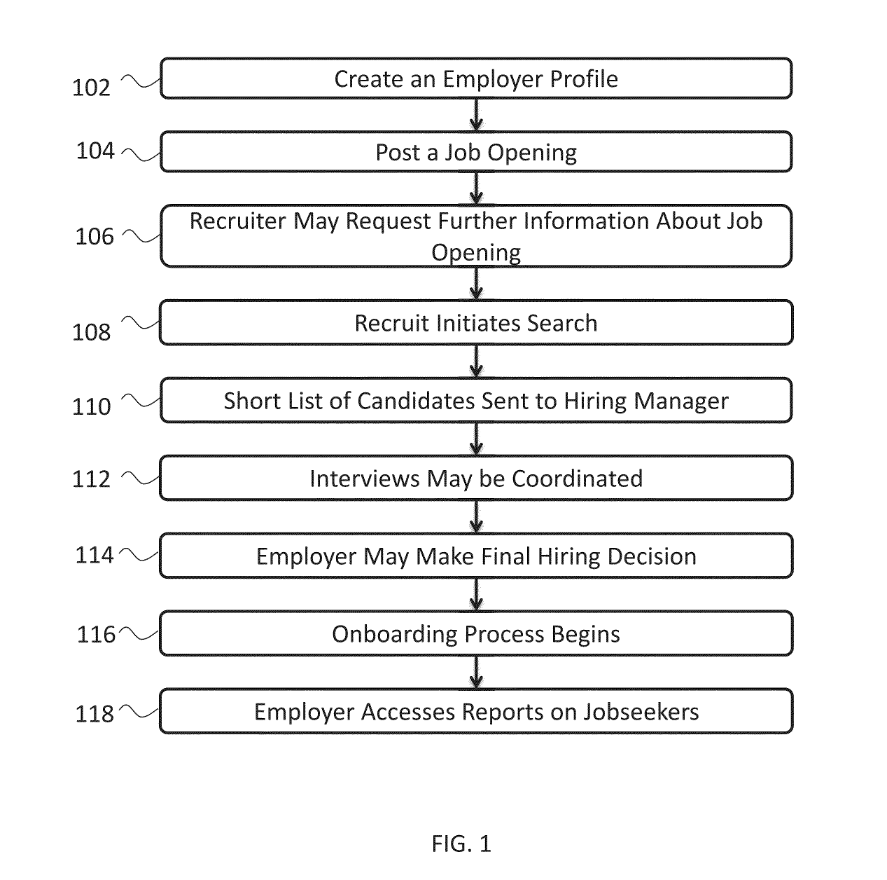

Now referring to exemplary FIG. 1, a prospective employer may be engaged in the recruiting process through a collaborative system and platform for hiring and onboarding. The employer or a representative thereof, such as a hiring manager, may generate an account in the system. The account may allow the employer to create a profile 102, which may provide information to the recruiting agency. The employer may also be able to create a public profile, which may be viewed by prospective hires or jobseekers through job posting databases, portals, or websites. The account may also be used to associate records stored in a system database. Prospective employers may send job openings to recruiting agencies or vendors, or the prospective employers may post job openings along with descriptions and requirements for the specific opening through the system account 104. The post may be viewed by the recruiting agency for the purposes of the coordinators. In some exemplary embodiments, the post may further become visible to jobseekers through the system. Once a coordinator has reviewed a job opening for a specific employer, the coordinator may contact the hiring manager to obtain more specific details of the job and desirable candidate aspects 106, if necessary. In some exemplary embodiments, the hiring manager may be able to indicate through the posting whether further communication is desired for the particular posting. If not, a coordinator may base the search off the information provided in the initial posting.

Based on the posting and any follow-up information, a coordinator may access databases of jobseekers to search 108. The jobseeker databases may include those of the recruiting agency or those of sub-vendors or other recruiting websites. There may be multiple layers of sub-vendors in some exemplary embodiments. Coordinators may then narrow a pool of candidates obtained from the jobseeker databases. The pool may also be determined by jobseekers who indicated interest in a position. The pool may be initially narrowed through automated criteria matching, such as desired location, desired field, degrees, testing scores, and other criteria as would be understood by a person having ordinary skill in the art. Once the initial criteria have been matched, a coordinator may review the jobseeker candidates to further match the information and requirements obtained from the job posting and any additional communications with the hiring manager. The further review of jobseekers may include review of submitted documents and personal interaction, such as interviews. Once the additional review has been completed and the pool has been further narrowed, the coordinator may provide a shortlist of matching candidates to the hiring manager 110. The hiring managers may then review the list and further narrow the jobseekers as desired to create a final list of candidates. Once the final candidate pool has been decided, the system may be used to coordinate interviews or other interactions between the employer and jobseekers 112. Other interactions may include providing writing samples, test cases, and other information. To coordinate interviews and in-person interactions, the hiring manager may enter scheduling options into the system and jobseekers may select a desired scheduling option. In some embodiments, jobseekers may submit available times and the system may match a plurality of jobseekers to the scheduling options posted by the hiring managers to best accommodate the many parties. Once interviews and all additional information have been analyzed by the hiring manager or employer, the employer may choose to select or not select a candidate for hire 114. The employer may also choose to provide feedback on the pool of jobseekers to improve future candidate matching. The feedback may be linked to the employer's account so that coordinators can review the feedback during future searches.

Next, the process of onboarding the new hire may begin 116. Onboarding may entail the assimilation process for new hires. Onboarding may begin by supplying a new hire with necessary information and documents through the system. The information and documents may be for review prior to a new hire's first day on the job. The new hire may return signed documents, such as employee contracts, through the system. Documents may be signed and returned through an e-signature process, uploading scanned documents, or other known processes, as would be understood by a person having ordinary skill in the art. Other information uploaded to the system by the employer for the new hire to review may include orientation information and videos, initial project scoping documents, and other documents that may facilitate the new hire's transition. In an exemplary embodiment, this may include contractual agreements, URL access, office floor plans, remote access instruction, software installation, security badges, immigration forms, and other information as would be understood by a person having ordinary skill in the art. An employer or hiring manager may subsequently access reports on jobseekers using a system dashboard 118.

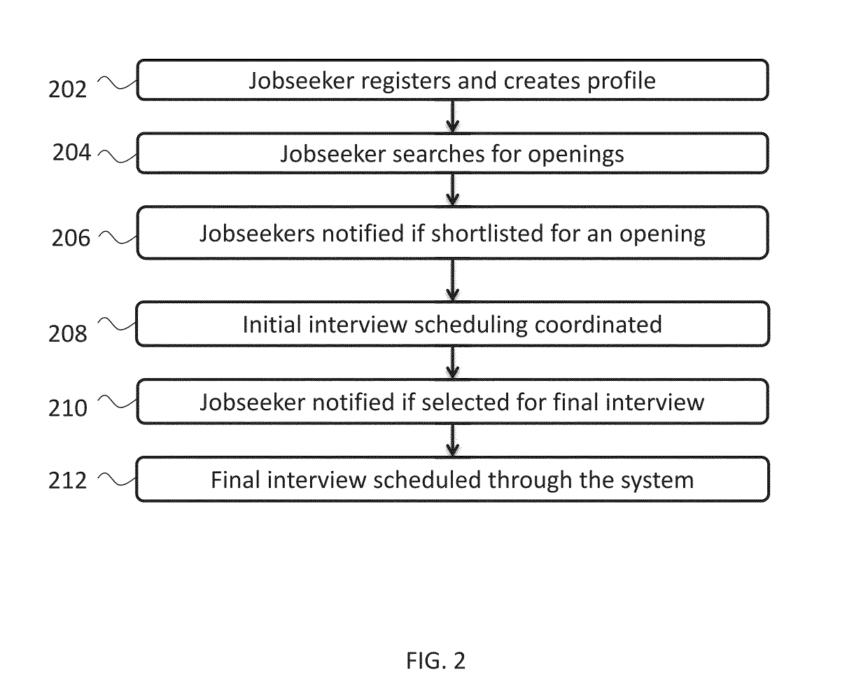

Now referring to exemplary FIG. 2, a jobseeker may access and engage the system through a website portal or mobile application. A jobseeker may sign up for an account with the recruiting agency through the portal or mobile application. The jobseeker may create a profile associated with the account 202. The profile may include desired job criteria, such as location and field of work. The jobseeker may further upload supporting documents to the profile. These documents may include resumes, cover letters, writing samples, transcripts, etc. Jobseekers may search and apply for specific job postings through the system and in some embodiments, jobseekers may choose to enter a general pool of jobseekers that coordinators may access to find matches for certain positions 204. A general matching algorithm may be used to narrow the pool of applicants for a position. The algorithm may match a jobseeker to a position based on desired location, desired field, degrees, scores, and other criteria as would be understood by a person having ordinary skill in the art. The matching algorithm employed may apply a weight to each of the criteria. Candidates matching with the highest overall weight may indicate the most desirable candidates. In one exemplary embodiment, the type of job, whether full time, contract, contract-to-hire, part time, or an internship, may be given a weight of 100. A keyword search matching the job posting and the candidate resume, including experience in recent years, may also be given a weight of 100. Skillsets may be given a weight of 100, experience may be given a weight of 50, location may be given a weight of 50, current job title may be given a weight of 25, expected salary may be given a weight of 25, and international experience may be given a weight of 25. The weights or criteria may be adjusted as desired.

Matched jobseekers may be ranked based on the criteria and a narrowed pool of jobseekers may be selected. The size of the narrowed pool may be predetermined by a coordinator. In an exemplary embodiment, a hiring manager may post a job, candidates may apply, and the candidate pool may be narrowed to the top 5 candidates based on job requirements and skillsets and the resume of the candidates. A coordinator may contact the narrowed pool of jobseekers through the system to request further information or schedule an initial interview. The system may generate a notification, such as an e-mail or alert, informing the jobseeker of the request 206, or otherwise contact the jobseeker as would be understood by a person having ordinary skill in the art. Once selected, a jobseeker may have access to additional information and to an interface for uploading additional documents or responding to further inquiries. The jobseeker may also have access to a scheduling interface for scheduling an interview 208. The scheduling interface may optionally be presented as a calendar. As referenced above, the scheduling interface may include available times posted by a coordinator, professional, or employer. In some exemplary embodiments, an initial interview may be conducted by the coordinator or a professional working with the recruiting agency. In alternative exemplary embodiments, the initial interview may be conducted by a representative of the employer, such as a hiring manager. Jobseekers who are selected to move past the initial interaction may be recommended for review and further evaluation by the employer, including through interviews, test projects, and other evaluation related interactions as would be understood by a person having ordinary skill in the art. If selected for a final interview with an employer, the coordinator or system may notify the jobseeker 210. The interview scheduling may again be coordinated through the system 212. Once an employer has selected jobseekers to hire, the employer and new hire may continue to interact through the system. This may entail the onboarding process 214.

During onboarding, as discussed above, jobseekers that have become new hires, may access employment contracts, employee handbooks, other employment documents, and in some embodiments, the new hires may access information relating to the work they will be performing. The system may further provide a platform for introducing the new hire to other employees. Also during onboarding, a jobseeker may contact a coordinator through the system to present further questions regarding the onboarding process. Jobseekers may further provide feedback on the hiring process during onboarding 216. Jobseekers may be given an opportunity to refer friends or colleagues, in which case the system may reward the jobseeker 218. The reward may be in the form of a monetary reward.

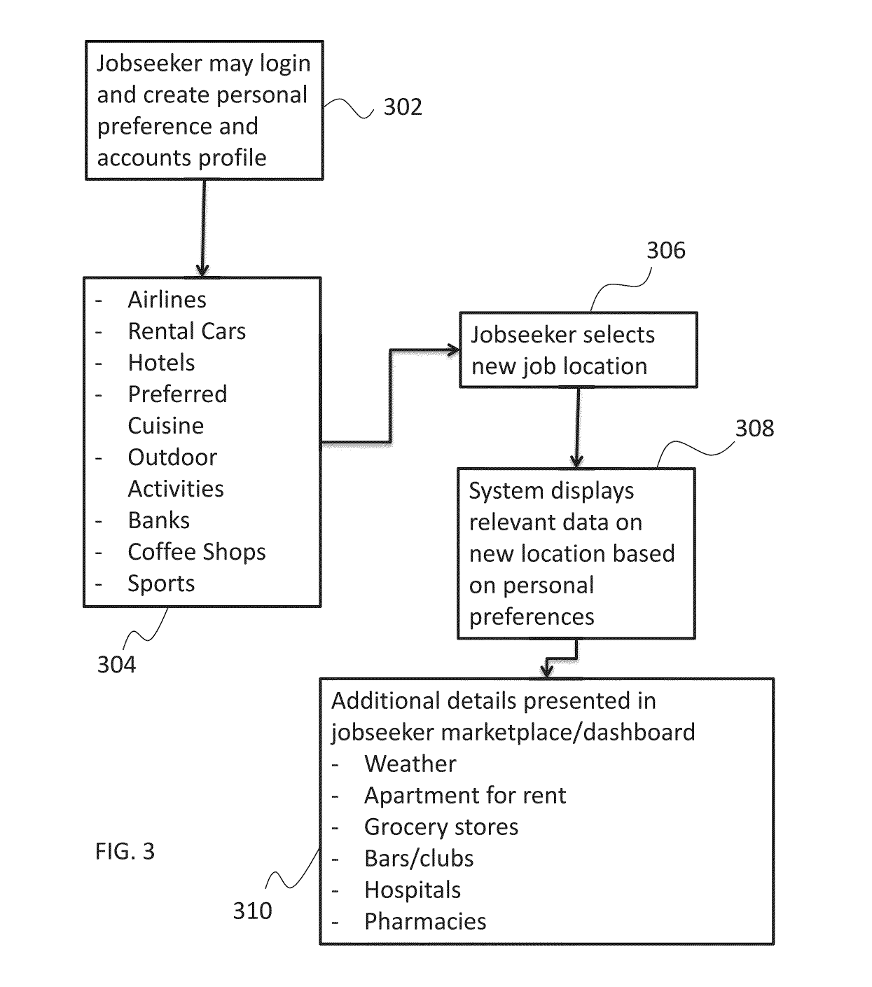

In addition to facilitating the recruiting process and onboarding, the system may allow jobseekers to maintain personal accounts used in association with the recruiting process, such as rewards accounts for hotels, flights, rental cars, and other amenities 220. This may allow jobseekers to maintain their personal accounts used in relation to work in a central repository. As shown in exemplary FIG. 3, a jobseeker may identify and maintain personal preferences and accounts through a jobseeker dashboard or marketplace portion of the system 302. The personal preferences and accounts may include airlines, rental cars, hotels, preferred cuisine, outdoor activities, banks, coffee shops, and sports 304. A jobseeker may select a new job location 306. The system may provide relevant data on a new job location based on the jobseekers preferences 308. The system may further provide additional details 310 for the jobseeker's benefit, such as weather, housing information, grocery stores, bars/clubs, hospitals, pharmacies, schools, and other information that a jobseeker may be interested in regarding a new location.

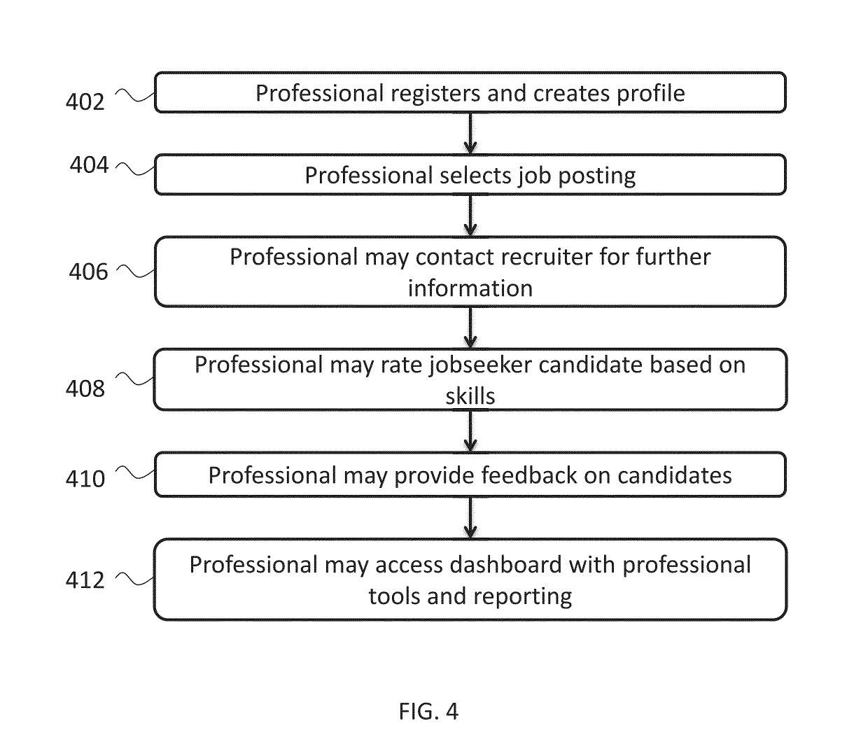

Now referring to exemplary FIG. 4, professionals, or experts, may be used to provide more effective matching based on specific position requirements and responsibilities. Professionals may sign up or register with the system and create a profile, which may indicate their experience and expertise 402. The professionals may be utilized to narrow candidate pools for a particular position based on their expertise. The professionals may be utilized to narrow a candidate pool at any time during the recruiting process. In some exemplary embodiments, professionals may be used to narrow a candidate pool prior to presenting the candidates to an employer. A professional may be able to select a job posting based on a field of expertise to review a candidate pool 404. In some exemplary embodiments, the system may only show professionals job openings related to their expertise. A professional or pool of professionals may be matched with a job based on job requirements and experience required for the position. A matching algorithm may be employed to select the professional or pool of professionals for a position. In an exemplary embodiment, the algorithm may apply weights to various criteria to be matched. For example, experience may have a weight of 100, a keyword search within the job posting and the recent experience of the professional may have a weight of 100, the type of job may have a weight of 100, skillsets may have a weight of 50, availability of the professional may have a weight of 50, international experience may have a weight of 25, if necessary, and location may have a weight of 25. Professionals having higher overall weights may be more desirable and subsequently selected. The weights and criteria may be adjusted as desired. The professional review process may be limited to certain types of positions, such as full time, contract, or contract-to-hire positions. The number of professionals may be picked by the system based on the type of position, duration of the job, and salary or hourly rate for the job.

Once selected, professionals may review a specific job posting and may analyze candidates based on all of the candidate's information in the system. Professionals may contact a coordinator associated with the position to obtain any desired clarifications on the job details or desired candidates 406. In some exemplary embodiments, professionals may additionally interview candidates to make their recommendations. Professionals may rate jobseekers during initial interviews and in some embodiments, also in final interviews. Professionals may rate the jobseekers based on skillsets and other metrics 408. In addition to rating jobseekers in a candidate pool, in some embodiments, professionals may be able to recommend or refer candidates outside the pool. In an exemplary embodiment, professional feedback may be used internally to measure the skillset of a jobseeker 410. Professionals may further have access to a dashboard, which may include professional tools and reporting 412. Additionally, in some embodiments, professionals may be paid as an incentive for their contribution. Professionals may view their earnings through the dashboard. This may include earnings for rating a candidate based on profile review, an initial interview or a final interview for a particular job posting. Additionally, in some embodiments, professionals may be reviewed by employers and may further be identified as a preferred professional for future openings.

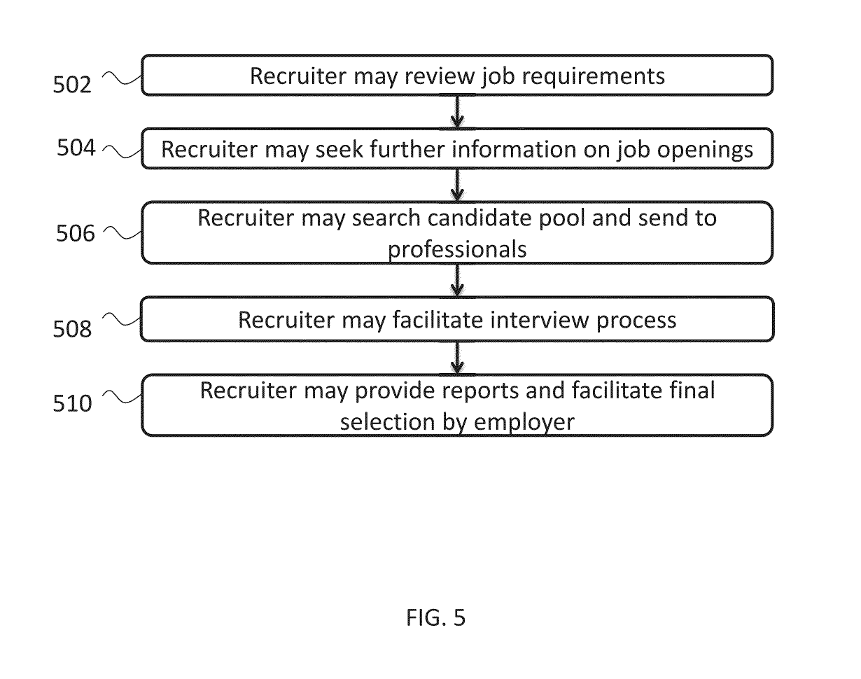

Now referring to exemplary FIG. 5, a coordinator may be utilized as a liaison between jobseekers, professionals, and hiring managers or employers, as described above. A coordinator may review job postings submitted to the system by an employer, client, or hiring manager 502. The coordinator may then follow up regarding any additional information or desired clarification on the position 504. The coordinator may trigger the system to perform an initial candidate match, narrowing a pool of jobseekers. The coordinator may then further narrow the pool, adjust the search criteria to amend the pool, or send the narrowed pool of jobseekers to professionals for further review 506. The coordinator may further supervise and facilitate an initial interview process, including scheduling 508. The coordinator may provide reports and access to candidate pools to employers or hiring managers and the coordinator may assist the employer or hiring manager in setting up final interviews for selected jobseekers 510. The coordinator may also coordinate professional payments.

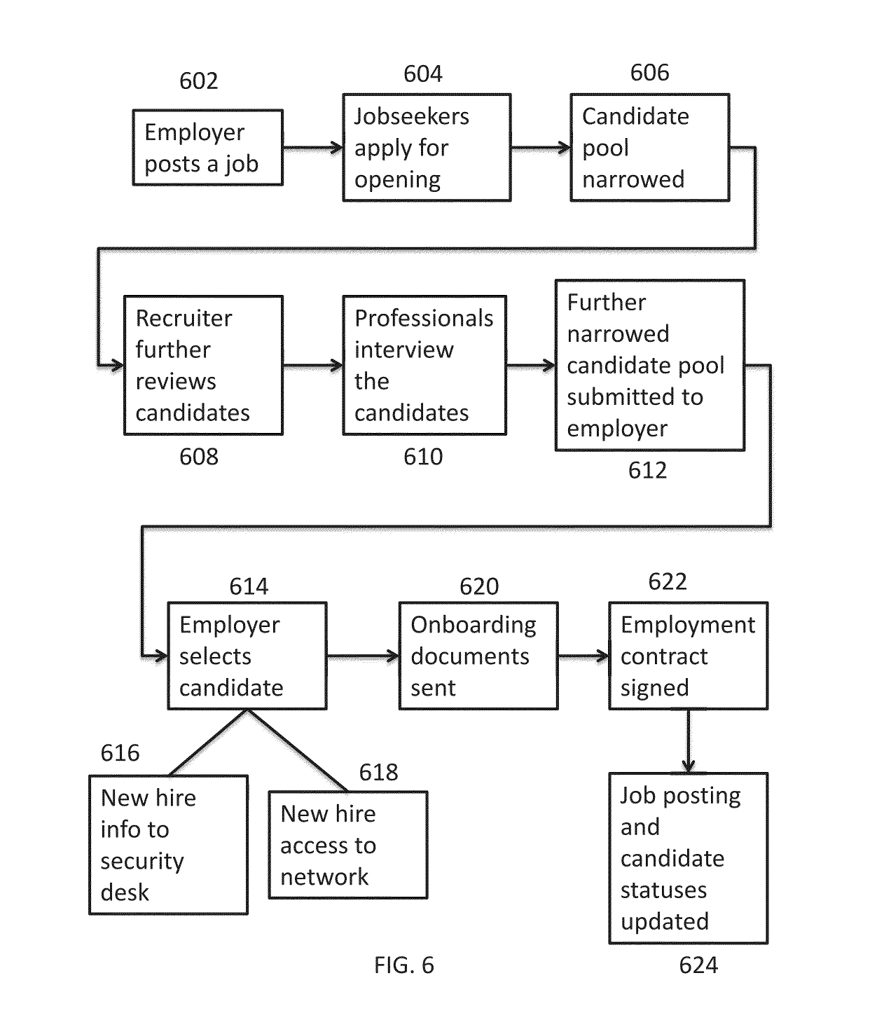

As shown in exemplary FIG. 6, a recruiting process may proceed as follows. An employer may post a job 602. Jobseekers may apply for the posted job 604. A candidate pool may be narrowed by an algorithm run on a server, which may compare criteria relating to a job with data provided by a jobseeker 606. A coordinator may further review the narrowed candidate pool 608. The coordinator may set up professional review of the narrowed candidate pool 610. The candidate pool may be further narrowed based on the coordinator and professional review. The further narrowed pool may be submitted to the employer 612. The employer, or a hiring manager thereof, may decide to hire a candidate 614. Appropriate information on the new hire may be provided to an employer security desk 616, the new hire may be granted employer network access 618, and onboarding documents may be sent to the new hire 620. An employment contract may be signed by the new hire and the hiring manager 622. The job posting may be removed or updated to reflect that it is now closed. The new hire's status in the system may be updated to reflect that the new hire is currently working on a project and is not available as a candidate for other positions 624.

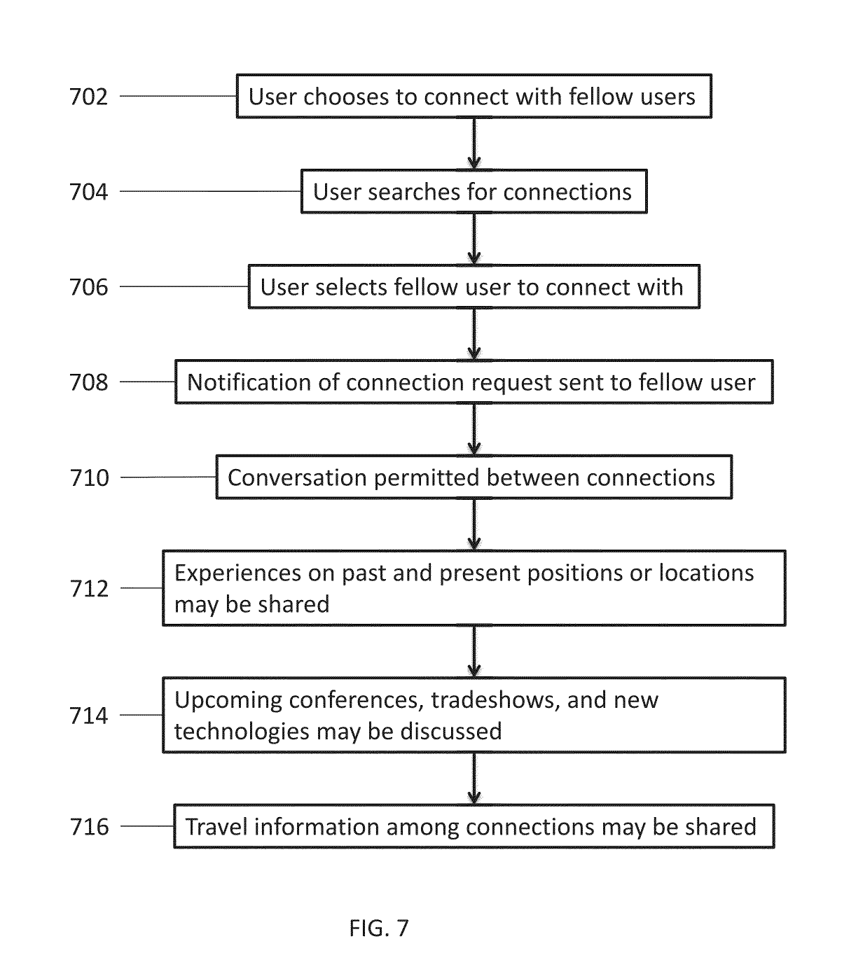

Now referring to exemplary FIG. 7, the system may provide for a collaborative platform through which users may interact. A user may choose to connect with other users, including jobseekers, professionals, coordinators, and employers 702. The user may search 704 fellow users by name, industry, city or other desired criteria in the system database. The search may provide results including a name, industry, and a picture. Additionally, the system may provide for a connection network among users, or the system may link to other social networks. These connections through the system or other social networks may be provided in the results. The user may select a fellow user with whom to connect 706. A notification may be sent to that user 708. The users may carry out a conversation through the system 710. Users may further share their experiences at current or previous jobs or locations 712. The users may also connect regarding industry conferences, trade shows, or new technologies 714. The system may additionally provide for sharing travel information among connected users 716.

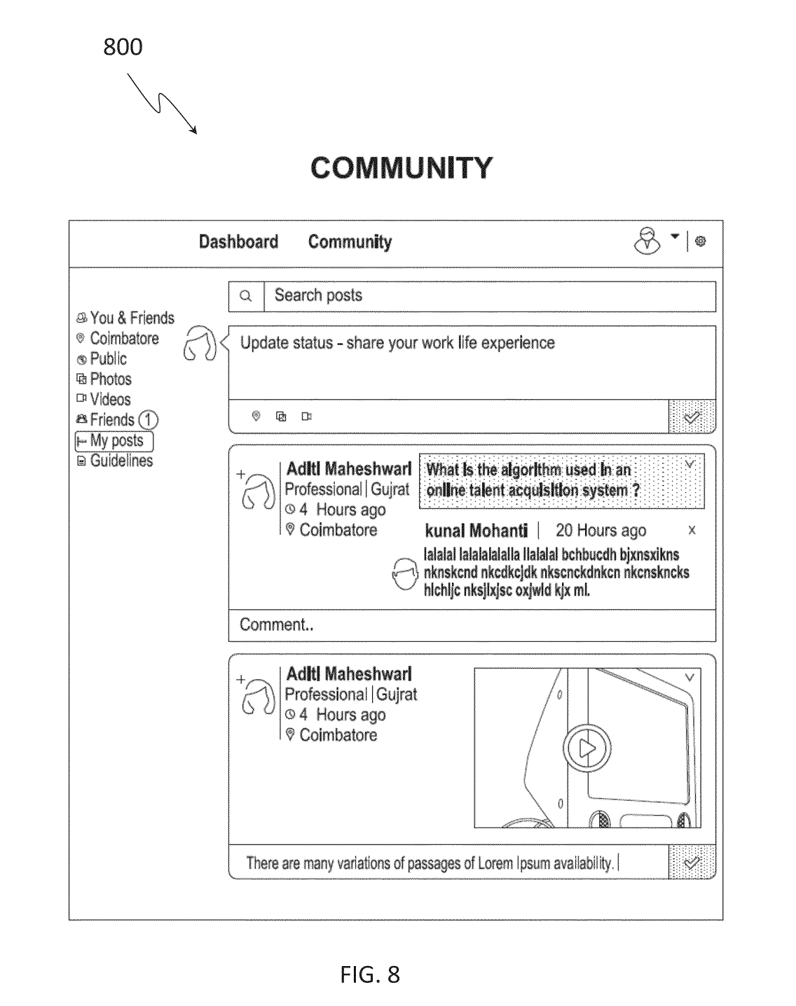

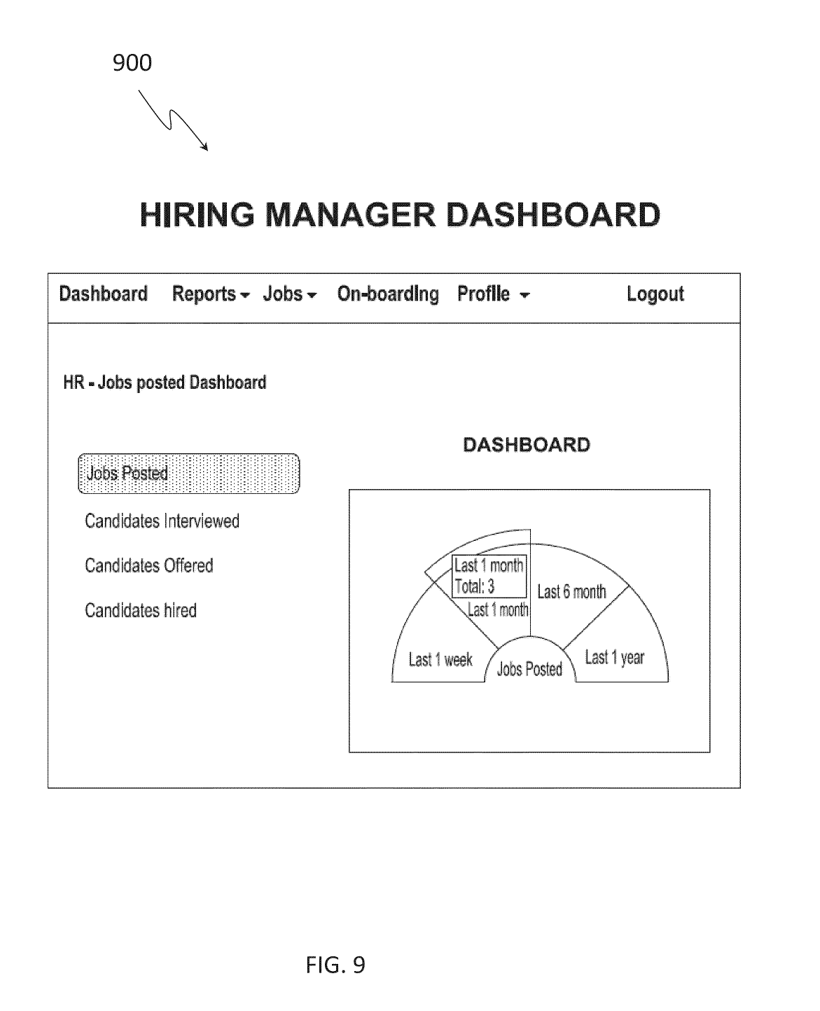

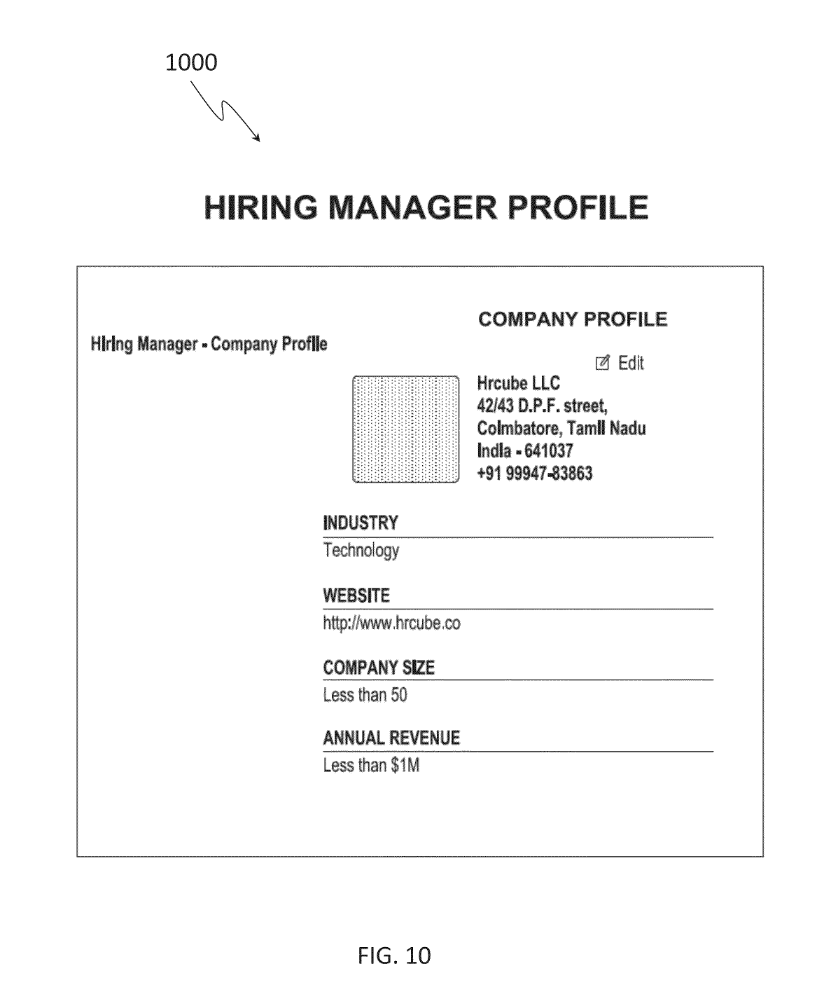

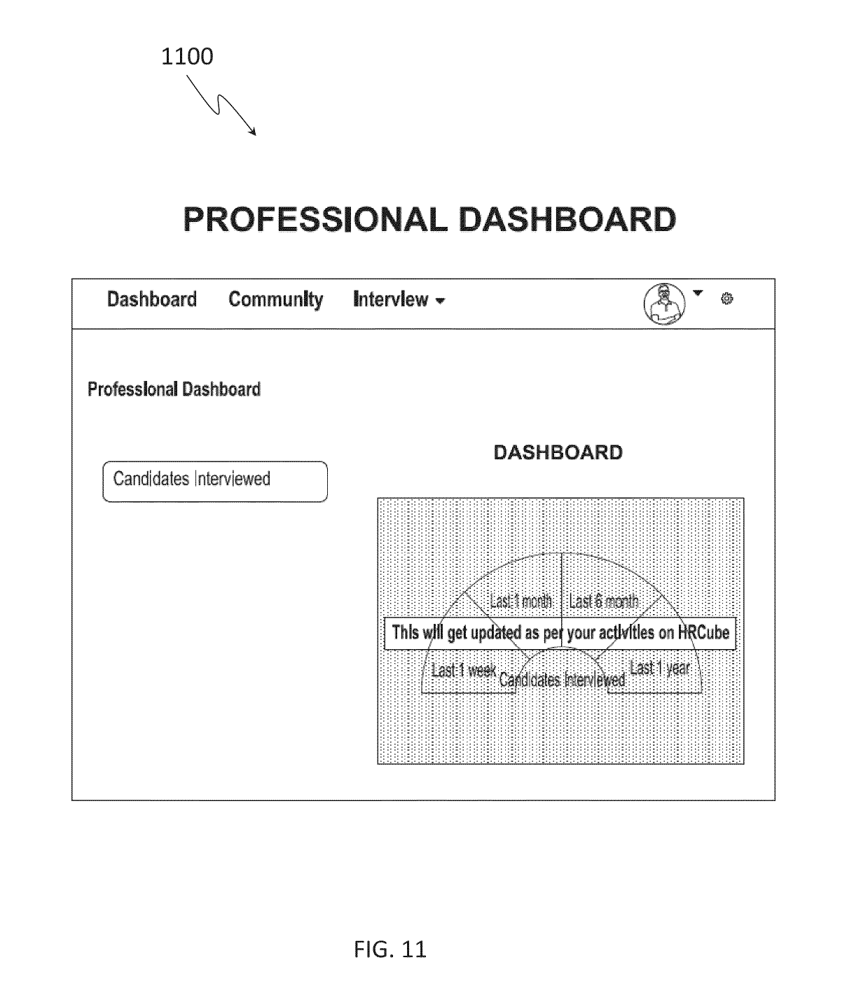

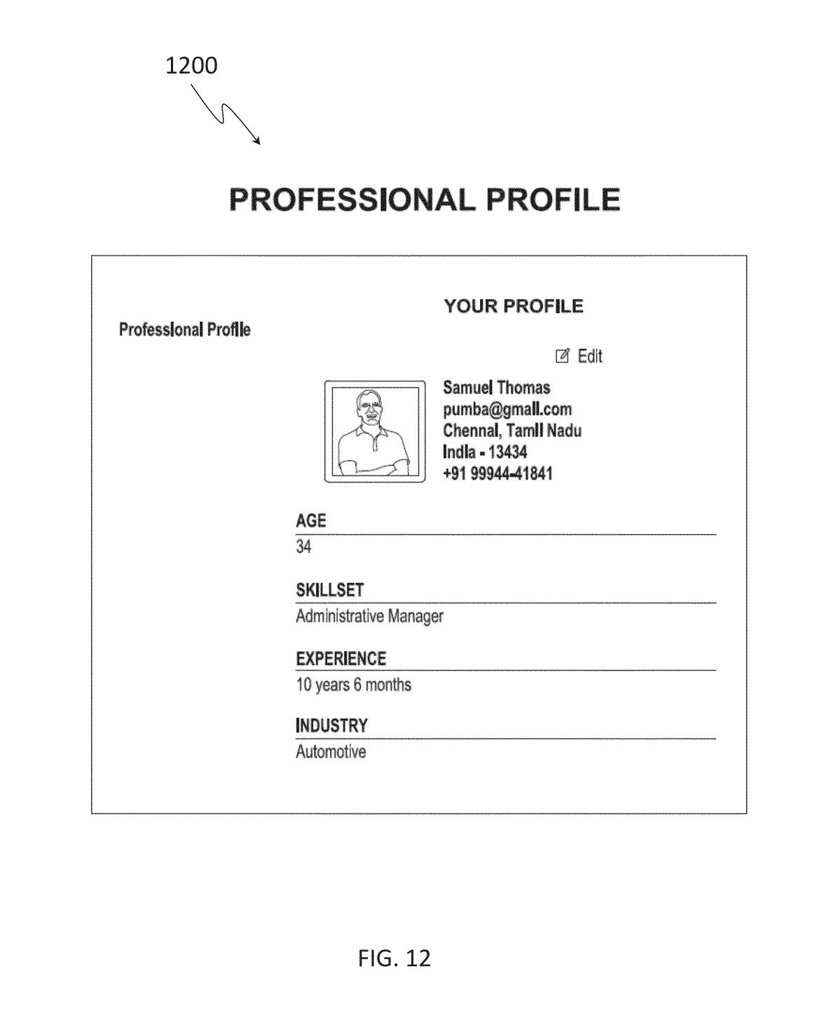

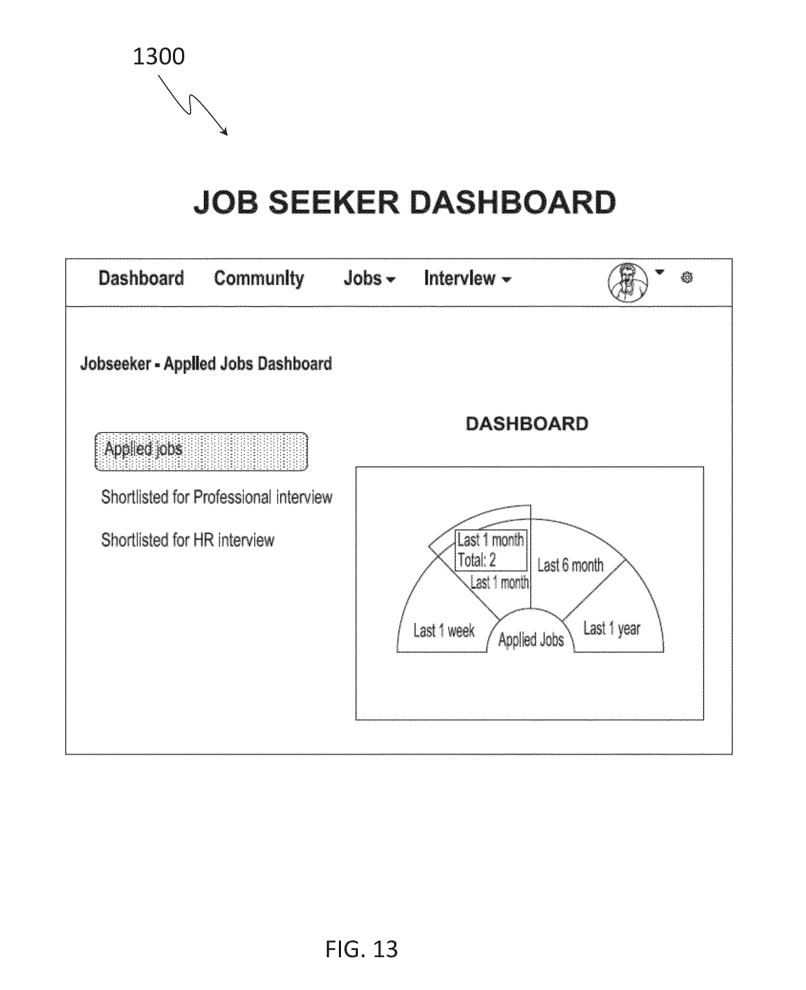

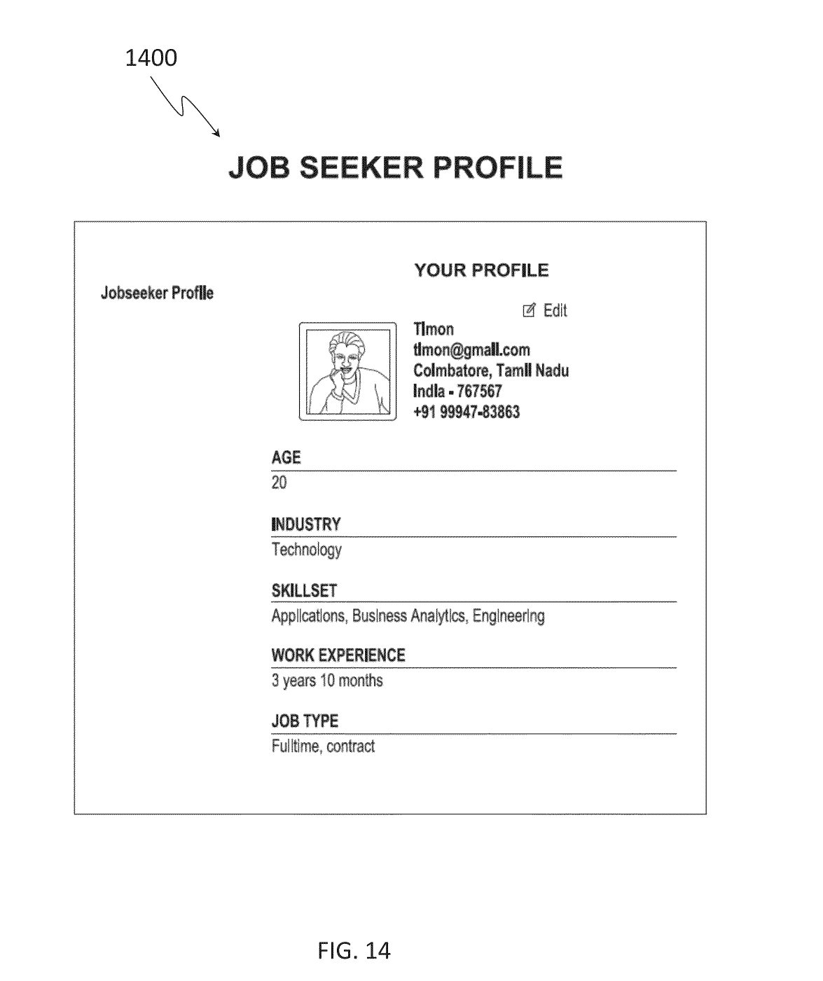

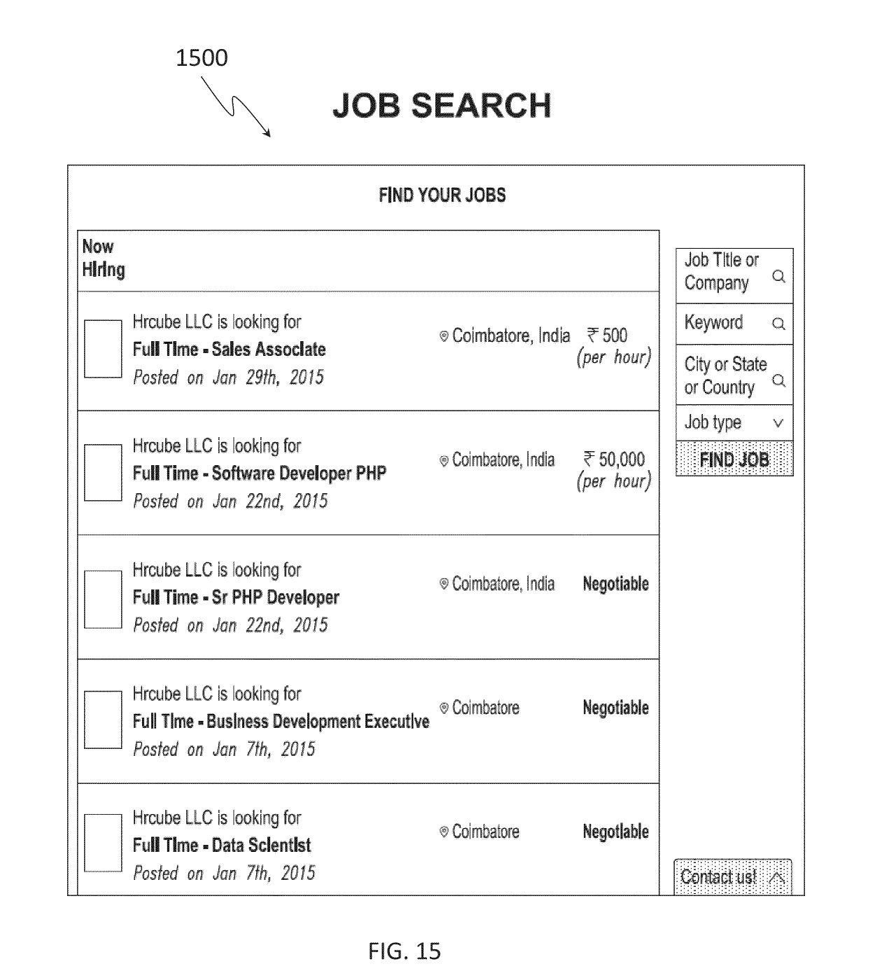

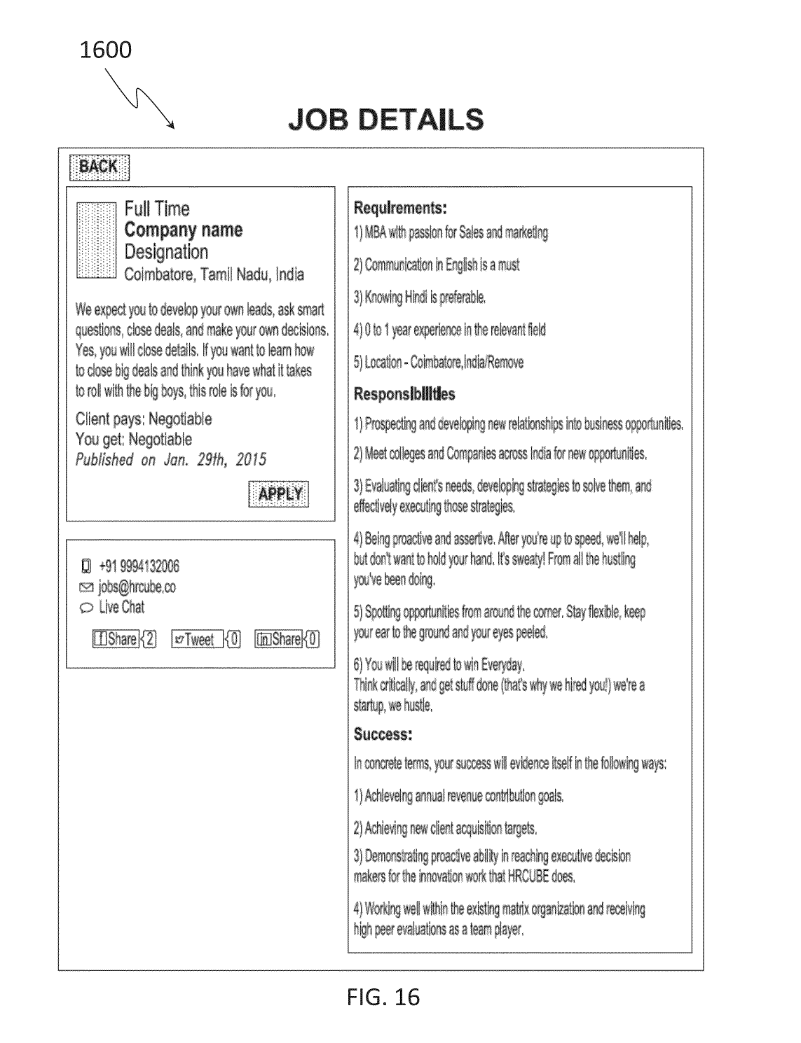

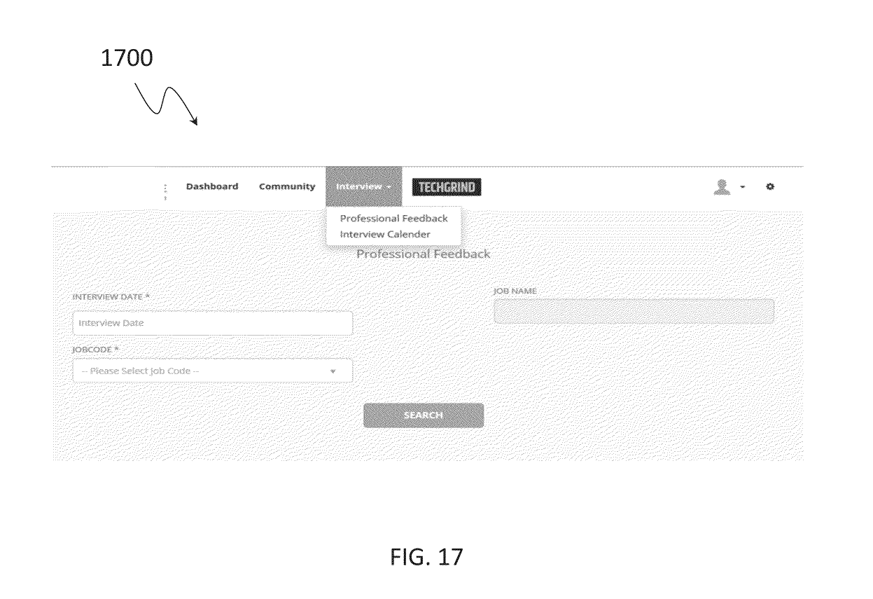

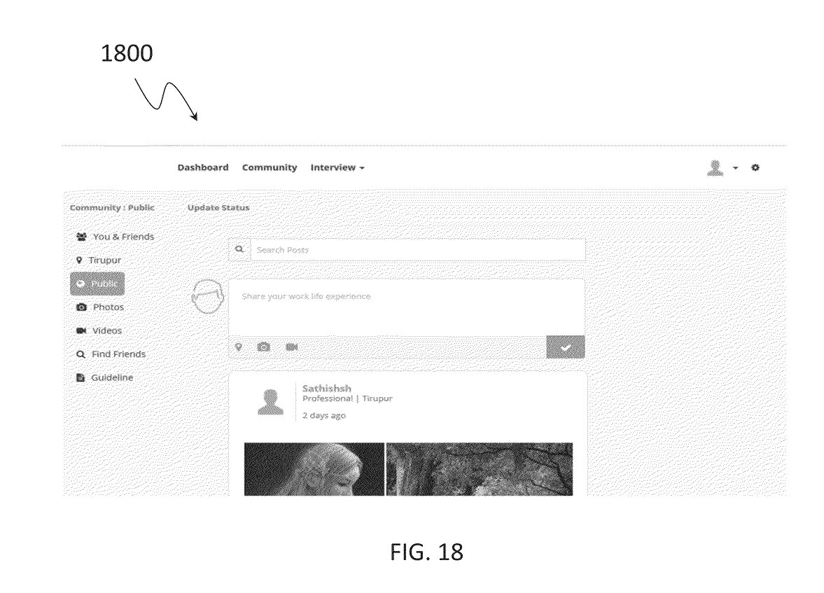

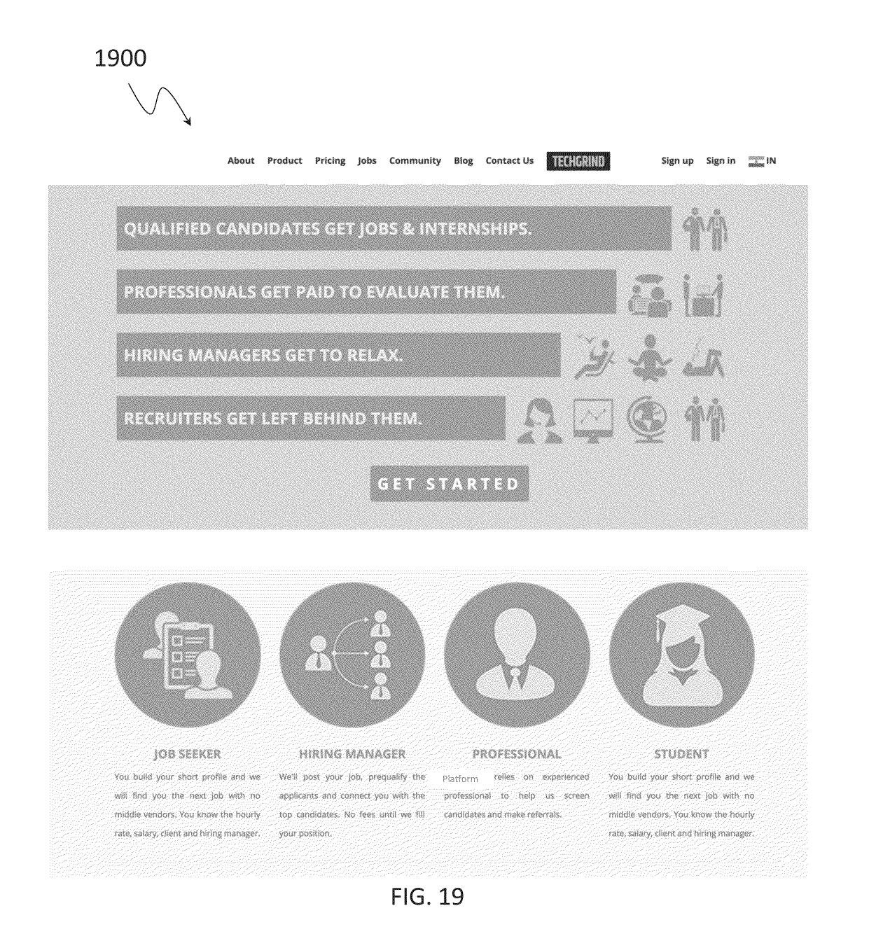

Now referring to exemplary FIG. 8-16, some exemplary user interfaces may be provided. In exemplary FIG. 8, a community interface 800 may be provided. Users may utilize the platform and interact as described above through community interface 800. In addition to the community interface 800 provided in FIG. 8, each user may have a personalized dashboard and user profile for utilizing the system, as described in detail above. For example, an exemplary hiring manager dashboard 900 may be provided in FIG. 9 and an exemplary hiring manager profile 1000 may be provided in FIG. 10. In exemplary FIG. 11-12, a professional dashboard 1100 and professional profile 1200 may be provided. In exemplary FIG. 13-14, a job seeker dashboard 1300 and jobseeker profile 1400 may be provided. In some exemplary embodiments, a coordinator may optionally have a dashboard and/or profile. As shown in exemplary FIG. 15, a job search interface 1500 may be provided. A job seeker or professional may utilize a job search interface 1500, as described above. Job search interfaces 1500 may optionally differ for different types of users, such as job seekers or professionals. A user may also access a job details interface 1600, which may optionally be prepared by a coordinator or hiring manager as described above. A job details interface 1600 may provide additional information on job postings. Further, a professional feedback interface 1700, which may be visible to professionals after login, may be provided in exemplary FIG. 17. An alternative embodiment of a community interface 1800 may be provided in exemplary FIG. 18. Finally, a platform home page interface 1900, which may be visible prior to login, may be provided in exemplary FIG. 19. The above described user interfaces may provide exemplary embodiments for implementing hiring, onboarding, and collaborating as described herein. However, user interfaces may be modified as would be understood by a person having ordinary skill in the art.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A method of recruiting and onboarding comprising:
providing a hiring, onboarding, and collaborating system having a server configured to store and compare employer data, job posting data, jobseeker data, and professional data;
providing a user interface for employers, jobseekers, professionals, and coordinators;
allowing an employer to post a job opening to the system;
allowing jobseekers to apply for a posted job opening;
running an algorithm to narrow a pool of jobseekers for an opening;
allowing a coordinator to further narrow a jobseeker pool using professional review and interviews;
providing a narrowed list of jobseekers to an employer for final review;
allowing an employer to select a jobseeker as a new hire;
presenting necessary onboarding documents and information to the new hire;
facilitating the transfer of signed employment contracts between the new hire and employer; and
requesting feedback from the employer, jobseekers, and professionals.

2. The method of claim 1, further comprising scheduling jobseeker interviews through a system interface.

3. The method of claim 1, further comprising facilitating the storage of personal account information and personal preferences through a system interface.

4. The method of claim 3, wherein the personal account information and personal preferences include at least one of airlines, rental cars, hotels, preferred cuisine, outdoor activities, banks, coffee shops, and sports.

5. The method of claim 1, further comprising providing information on the location of a job opening.

6. The method of claim 5, wherein the information includes at least one of weather information, housing information, grocery stores, bars/clubs, hospitals, pharmacies, and schools.

7. The method of claim 1, further comprising allowing users to connect and engage one another through a system interface.

8. A recruiting and onboarding apparatus comprising:
at least one server;
at least one network;
at least one employer device configured to communicate over the at least one network with the at least one server;
at least one jobseeker device configured to communicate over the at least one network with the at least one server;
at least one coordinator device configured to communicate over the at least one network with the at least one server;
at least one professional device configured to communicate over the at least one network with the at least one server;
wherein the at least one server is configured to:
allow an employer to create a profile,
allow the employer to post a job opening such that a jobseeker can apply for the opening,
search and narrow a jobseeker pool based on job opening information and jobseeker data,
allow at least one coordinator or professional to select a job opening to further review jobseekers,
allow the coordinator or professional to further narrow the jobseeker pool for submission to the employer, and
allow an employer to select a jobseeker for hire based on the data.

9. The recruiting and onboarding apparatus of claim 8, wherein the server is further configured to facilitate the sharing of documents between employers and jobseekers.

10. The recruiting and onboarding apparatus of claim 8, wherein the server is further configured to store jobseekers' personal accounts and preferences.

11. The recruiting and onboarding apparatus of claim 10, wherein the personal accounts and preferences include at least one of airlines, rental cars, hotels, preferred cuisine, outdoor activities, banks, coffee shops, and sports.

12. The recruiting and onboarding apparatus of claim 8, wherein the server is further configured to provide information on the location of a job opening.

13. The recruiting and onboarding apparatus of claim 12, wherein the information on the location of a job opening includes at least one of weather information, housing information, grocery stores, bars/clubs, hospitals, pharmacies, and schools.

14. The recruiting and onboarding apparatus of claim 8, wherein the server is further configured to facilitate the scheduling of jobseeker interviews.
